(19) United States
(12) Patent Application Publication
(10) Pub. No.: US 2012/0279328 A1
(43) Pub. Date: Nov. 8, 2012

(54) HUMAN-POWERED DEVICE USING TWO LEVERS AND HUMAN-POWERED VEHICLE PROVIDED WITH AFOREMENTIONED DEVICE

(76) Inventors: Tokio Nakagawa, Okayama (JP); Masayoshi Nakagawa, Okayama (JP); Tomori Nakagawa, Okayama (JP)

(21) Appl. No.: 13/499,689

(22) PCT Filed: Oct. 8, 2010
(86) PCT No.: PCT/JP2010/067789

§ 371 Date: Jun. 11, 2012

(30) Foreign Application Priority Data
Oct. 21, 2009 (JP) 2009-242144

(51) Int. Cl. B62M 1/04; F16H 19/08

(52) U.S. Cl. 74/33

(57) ABSTRACT

Atmospheric pollution and global warming have been caused due to conversion of petroleum, natural gas and atomic energy into electrical energy and continued use of the first two of these energy sources as engine fuel. Such being the case, there is a pressing need to use alternative energy and to change from using power mechanisms to using alternative types of mechanisms. Disclosed is a human-powered device provided with a first lever and a second lever. A large force is generated using a first lever. By means of a second lever, the force is further amplified, and swing amplitude is enlarged. The fulcrum position is made to move, with the result that the second lever is provided with a continuously variable function. A pinion makes normal or reverse rotation according to the movement of the second lever, which swings. By means of a ratchet mechanism provided at a first shaft, this normal or reverse rotation is converted into rotation made in one direction only by a gear wheel. This gear wheel causes a small pinion on an output shaft to rotate, with the result that the swinging movement caused by the levers is converted into rotational movement and is taken out. In this way, a drive mechanism is created which does not require fuel or a drive energy source.

### FIELD OF INVENTION

This invention relates to a human-powered device using two levers and a human-powered vehicle provided with the aforementioned device.

### BACKGROUND TECHNOLOGY

Expensive natural resources such as petroleum, natural gas and coal are used for heat, electricity and energy for motion. This is leading to the exhaustion of energy resources, there is continuous discharge into the atmosphere of sulfur compounds and nitrogen compounds that are harmful to human health, and global warming is proceeding to a marked extent due to carbon dioxide for which there is no remedy. As the result, climate change has been brought about, there has been severe storm damage and increased aridity, and sea levels are rising due to polarization into regions of severe rain and melting of glaciers.

### EXISTING TECHNOLOGY [Prior Art]

### Patent Literature

Patent Reference 1: Japanese Patent Early Disclosure No. Heisei 9-[1997] 71287

Patent Reference 2: International Disclosure No. 2006/001450

### SUMMARY OF THE INVENTION

### Problem the Invention is Intended to Solve

Conventional drive devices use petroleum as a fuel and energy source, for which reason the discharged gases bring about severe damage to the human body and the natural environment. Vehicles such as automobiles and steam generating power plants that use petroleum as fuel employ drive mechanisms that discharge carbon dioxide and that cause the most severe damage to the environment, for which reason drive mechanisms that do not use petroleum are necessary.

The object of this invention is to provide a drive device that does not use petroleum as fuel and as an energy source, as well as a human-powered vehicle that is provided with the aforementioned device.

### Means for Solving Problem

In order to achieve the above-described object, the end of a first lever is affixed to a first lever fulcrum support component to form a fulcrum. In the vicinity of the fulcrum, a point of action is installed that is joined with a connecting component that provides power to a second lever, and, by placing a point of action at the end [of the second lever], the fulcrum is swung to the center. The force that has been generated by the first lever is the power that is provided to the connecting component. A power point that constitutes a toothed member is installed on the other end [of the second lever]; the second lever can cause a rotating roller-shaped fulcrum to be able to undergo sliding movement and the toothed member of the sliding second lever causes a pinion on a first shaft to rotate in a forward or reverse direction. By means of a ratchet mechanism, a gear wheel that rotates in only one direction causes a small pinion on an output shaft to rotate. By this means, the sliding movement due to the lever is converted into rotation and is taken out, and a human-powered drive device using two levers is produced.

By means of solving this problem, the device operates as described below. When the pedal that touches the fulcrum of the first lever is pressed, the first lever slides the fulcrum that is affixed by the first lever fulcrum support to the center. When the foot is taken off the pedal, a repeating force is generated that withdraws and slides the fulcrum to the original position when sliding was begun by means of a first lever withdrawal spring. The force that is generated is amplified and increases the force that is applied to the second lever by the connecting component. The rotating roller fulcrum that is installed close to the toothed member that that serves as the power point of the second lever slides to the center, the pinion of the first shaft is caused to rotate in the forward or reverse direction, but the small pinion of the output shaft is rotated by the output of the gear wheel that rotates in only one direction, by means of the ratchet mechanism that is installed on the same shaft, by which means the sliding movement is converted to rotational movement by the lever.

Further, at the time rapid motion is undertaken after standing still, the greatest force is generated by the action of the lever when the fulcrum position of the rotating roller that is installed in the second lever is closest to the toothed member, which is the power point. Further, when the rotation of the output shaft is accelerated, the fulcrum position of the rotating roller is guided into the fulcrum slide guide rail by the point of action B and the slide is moved. When it is caused to slide, the distance of the power point from the fulcrum is lengthened, by which means the peripheral velocity of sliding at the power point is accelerated, the pinion is caused to rotate rapidly and the number of rotations can be increased. Further, because the second lever slides by applying it to the external periphery of the roller-shaped fulcrum, the fulcrum position, at each time of sliding, is applied to the outside periphery of the roller-shaped fulcrum and moves closer to or further from the power point.

By causing the fulcrum of the second lever to undergo sliding in this way, the speed of the accelerating motion can be changed continuously, the sliding movement due to the levers being converted to rotational motion and being taken out, and a human-powered vehicle using two levers is created.

Accordingly, the following types of utility vehicle or bicycle-drawn cart can be considered. FIG. 1 is a rough sketch of a drive device in the original form. When it is modified as shown by the rough sketch in FIG. 3 with one pedal each on the left and right so that two feet can be applied and a baggage carrier is constructed, a bicycle or a bicycle-drawn cart can be obtained. By constructing it so that pedals can be pressed by both feet, it is possible to produce drive devices for vehicles for agricultural use and agricultural equipment such as tractors, rice planters and combines. Moreover, drive devices can be produced for ships for coastal use, railroad cars, small aircraft and sports vehicles.

### EFFECT OF THE INVENTION

Because human-powered drive devices using two levers obtained by means of this invention as described above do not make use of petroleum, gas, coal, and nuclear power or electrical energy produced by them, drive devices and human-powered vehicles equipped with them that do not generate discharge gases that harm the human body and the natural environment can be provided.

For this reason, there is no worry over depletion of energy resources and there is no discharge of sulfur compounds, nitrogen compounds or carbon dioxide, for which reasons drive devices and human-powered vehicles in which they are incorporated can be provided that do not harm human health, and that do not require energy that leads to increased damage due to storms, that do not bring about polarization into arid and highly rainy regions as a result of global warming, and that do not result in rising sea levels due to global warming.

When this drive device is used for vehicles, the following possibilities apart from alleviating environmental problems can be discerned. One possibility is that because operators of vehicles use a human-powered structure that drives and operates the vehicle, the vehicles operate in accordance with the disposition of the driver and there are few accidents that cause great losses. From the standpoint of convenience, risks due to social problems are further reduced.

### BRIEF EXPLANATION OF THE FIGURES

FIG. 1 is a rough sketch that shows the basic principle of this invention.

FIG. 2 is a rough sketch of the roller-shaped fulcrum.

FIG. 3 is a rough sketch of an embodiment of this invention.

### MODE OF EXECUTION OF THIS INVENTION

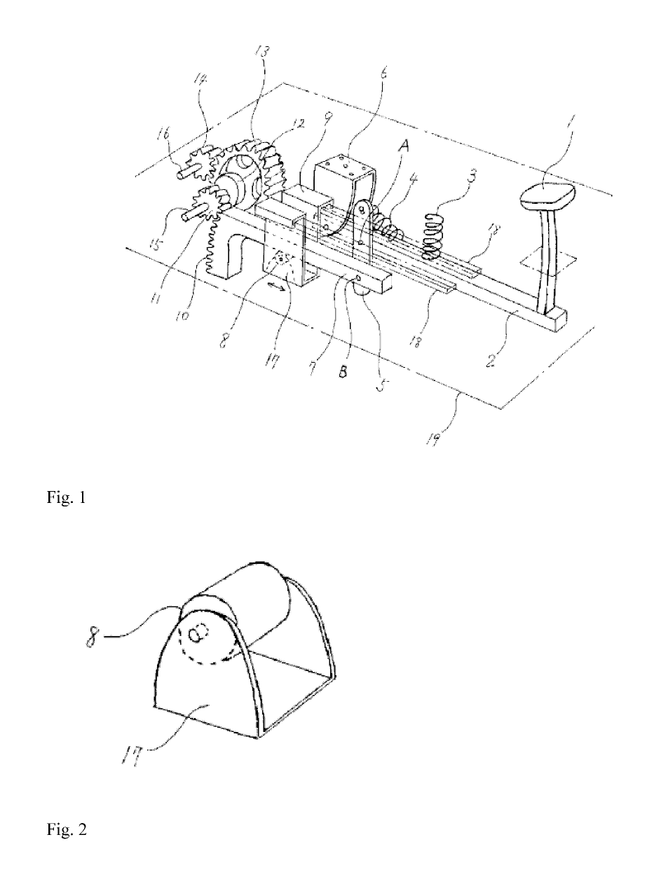

The basic principle of the mode of execution is explained below on the basis of FIG. 1. The end of a first lever 2 is fixed to a first lever fulcrum support component 6 to form a fulcrum. In the vicinity of the fulcrum, a point of action A of first lever 2 is installed and joined to a connecting component 5 that provides power to a second lever 7; a connecting component withdrawal spring 4 from first lever 2 is installed in one end of connecting component 5; a first lever withdrawal spring 3 is installed close to the point of action A; first lever 2 slides the fulcrum to the center with a pedal 1 that is installed at the other end as the point of force; there is a point of action B of second lever 7 that transmits the force that has been generated at first lever 2 to one end of second lever 7 by connection component 5. The power point which is represented by a toothed member 10 is installed in the other end [of second lever 7]. A roller-shaped fulcrum 8 is supported by a roller-shaped fulcrum support 17 so that it touches the external periphery of the roller between toothed member 10 that forms the power point and point of action B so that the fulcrum position slides, with a single unit being formed with a slide support component 9. The latter touches a fulcrum slide guide 18 as shown by the dotted line, causing the fulcrum position to move as desired. Second lever 2 and toothed member 10 of sliding second lever 7 cause a pinion 11 of a first shaft 15 to move in the forward or reverse direction so that the distance from toothed member 10 to the point of action B changes. By means of a ratchet mechanism 12, a gear wheel 13, which rotates in only one direction, causes a small pinion 14 of an output shaft 16 to rotate. Components 1 to 18 are constructed so that they are all suspended below a plane 19 which is shown by the dotted line and so that only pedal 1 appears above this plane.

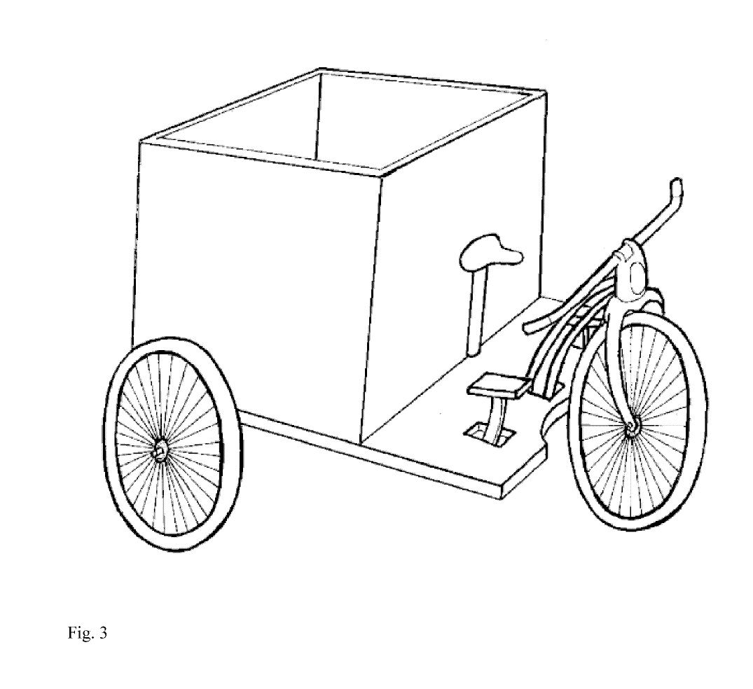

In this way, the sliding movement is converted into rotational movement and is taken out. As shown in FIG. 3, a platform is formed with one base on the left and one on the right forming two bases. In this way a human-powered drive device and a human-powered vehicle provided with this device are formed using two levers so that pedaling can be performed by both feet.

Next, we shall describe motion based on the above-described structure. First, when pedal 1 is pushed so that it touches the point of action of the first lever 2, the fulcrum that is supported by the first lever fulcrum support component 6 slides first lever 2 to the center. When pedal 1 that has been pushed is released, first lever 2 is returned to the position it was when sliding was begun by first withdrawal spring 3 so that pedal 1 can be pressed again.

When this is carried out, a large force is produced at the point of action A of the first lever that joins first lever 2 to connecting component 5; the force is transmitted when connecting component 5 comes into contact with one end of second lever 7, with point of action B being formed and with second lever 7 causing the roller-shaped fulcrum 8 to slide to the center.

By this means, pinion 11 of first shaft 15 moves in the forward or reverse direction, but, by means of ratchet mechanism 12, gear wheel 13, which rotates in only one direction, causes small pinion 14 of output shaft 16 to rotate.

When this series of movements is brought about, the second lever 7 can move freely backwards and forwards, for which reason the toothed member may not be aligned [with pinion 11]. In order to prevent this non-alignment, second lever 7 is not allowed to undergo the same movement. By establishing the connection component withdrawal spring 4 at one end of connection component 5 from first lever 2 with little change in distance, second lever 7 and pinion 11 of the first shaft are constantly alternated.

The function of the roller-shaped fulcrum 8, which is one of the major characteristics of this invention, is as follows. FIG. 1 is a rough sketch that shows the basic principle, for which reason several [additional] levers and related connection components with which operations are conducted are omitted and only the operations of the major components are described. When second lever 7 slides, the roller shaped fulcrum 8, which is continuously associated with second lever 7, comes into contact with second lever 7 by its external periphery, and the fulcrum position slides toward or away from the toothed member 10, which is the power point.

The roller-shaped fulcrum 8, which forms a single unit with the slide support component, is caused to undergo sliding movement as shown by the arrow relative to the toothed member 10 which is the power point. When it has slid to the closest position, its distance from the power point is shortened and the amplitude of sliding of toothed member 10 is decreased.

Next, sliding motion is effected as shown by the arrow so that the distance from toothed member 10, which is the power point, reaches a maximum length. When the force in pressing pedal 1 is the same, the circumferential velocity at toothed member 10, which is the power point, increases, and the rotation of pinion 11 of first shaft 15 accelerates.

When slide support component 9 is caused to slide along the fulcrum slide guide rail 18 in this way, the roller-shaped fulcrum 8 rotates, with the result that friction resistance decreases and sliding movement is facilitated.

As described above, by joining second lever 7 with the roller-shaped fulcrum 8 into a single lever, there is amplification of the force generated by first lever 2, which plays a role in increasing the amplitude, in sliding the fulcrum and in a continuous change of velocity.

A vehicle for practical use is designed so that the drive device causes motion by installing a platform on which there are two pedals, one on the left and one on the right, that can be pushed and are located on a single base. Three-wheeled or four-wheeled vehicles can be considered. With drive devices that are installed independently on the right and left, and when driving is regularly continued, moving parts can be eliminated to a great extent, for which reason, when drive is alternated between left and right, rationally, half the energy is consumed.

Further, in implementation, because the drive mechanism is placed on the inner side, by pushing only the pedal on the outer side, it can be operated at any radius depending on the steering angle.

### List of Reference Characters

1 Pedal

2 First Lever

3 First Lever Withdrawal Spring

4 Connection Component Withdrawal Spring

5 Connection Component

6 First Lever Fulcrum Support Component

7 Second Lever

8 Roller-Shaped Fulcrum

9 Slide Support Component

10 Toothed Member

11 Pinion

12 Ratchet Mechanism

13 Gear Wheel

14 Output Shaft Small Pinion

15 First Shaft

16 Output Shaft

17 Roller-Shaped Fulcrum Support Component

18 Fulcrum Slide Guide Rail

19 Plane

A Point of Action of First Lever

B Point of Action of Second Lever

1. A human-powered device using two levers in which the end of a first lever is affixed to a first lever fulcrum support component to form a fulcrum, in the vicinity of which fulcrum a point of action is installed that is joined to a connecting component that provides power to a second lever; a connection component withdrawal spring from the first lever is installed at one end of the connection component and a power point is installed at the other end; in the vicinity of the point of action, a first lever withdrawal spring is installed, the first lever sliding the fulcrum to the center by making the other end the power point, there being a power point that transmits the force that has been generated by the first lever by means of the connecting component; a power point that constitutes a toothed member is installed on the other end [of the second lever], there being a roller-shaped fulcrum that rotates between the toothed member that constitutes the power point and the point of action; the lever comes into contact with the external circumference of the roller and slides, by which means it can slide toward or away from the point of action making sliding possible; this roller-shaped fulcrum is affixed in the roller-shaped fulcrum support component so that sliding movement can be effected; a second lever is provided that has a double velocity-changing function due to the lever, an amplifying action on the force due to the ordinary [first] lever and that increases the sliding amplitude; the toothed member of the sliding second lever causes the gear wheel to rotate in only one direction by the ratchet mechanism, the sliding movement due to the levers being converted to rotational motion and is taken out.

2. A vehicle provided with the human-powered device described in claim 1.

3. A bicycle for practical use provided with the human-powered device described in claim 1.

4. A device for agricultural use provided with the human-powered device described in claim 1.
